(19) United States
(12) Patent Application Publication
(10) Pub. No.: US 2026/0370574 A1
(43) Pub. Date: Nov. 19, 2026

(54) Deploying Network Services based on Virtualized Network Functions

(71) Applicant: Telefonaktiebolaget LM Ericsson (publ), Stockholm (SE)

(72) Inventors: Arturo Martin de Nicolas, Brussels (BE); Calin Curescu, Håsselby (SE); Stefan Bjurström, Tumba (SE)

(21) Appl. No.: 19/475,539

(22) PCT Filed: Apr. 8, 2024
(86) PCT No.: PCT/IB2024/053439

§ 371 Date: Oct. 15, 2025

Related U.S. Application Data
(60) Provisional application No. 63/498,060, filed on Apr. 25, 2023.

(51) Int. Cl. H04L 41/40; H04L 41/0806; H04L 41/5054; H04W 4/50

(52) U.S. Cl. CPC H04L 41/40; H04L 41/0806; H04L 41/5054; H04W 4/50

(57) ABSTRACT

Embodiments include methods method for deploying network services, NS, based on one or more virtualized network functions (VNFs) available in a communication network. Such methods include obtaining a first NS descriptor (NSD) of a first NS. The first NSD includes an identifier of a VNF descriptor (VNFD) of a constituent VNF of the NS, and a first service access point descriptor (SAPD) of a first SAP of the NS. The first SAPD includes the following attributes associated with the first SAP: an identifier of the VNFD as a constituent element of the first SAP, an identifier of a first connection point (CP) of the VNFD, and a first mapping between the first CP and a first deployable module (DM) of the constituent VNF. Other embodiments include network management functions configured to perform such methods.

### TECHNICAL FIELD

The present application relates generally to the field of communication networks, and more specifically to techniques for deploying network services (NS) based on virtualized network functions (VNFs) available in a communication network, particularly VNFs that include virtualization deployment units (VDUs) that are not required to be included in VNF instantiations.

### INTRODUCTION

The fifth generation (5G) of cellular systems is being standardized within the Third-Generation Partnership Project (3GPP). NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

At a high level, the 5G System (5GS) consists of an Access Network (AN) and a Core Network (CN). The AN provides UEs connectivity to the CN, e.g., via base stations such as gNBs or ng-eNBs. As described in more detail below, the CN includes a variety of Network Functions (NF) that provide a range of different functionalities such as session management, connection management, charging, authentication, etc.

FIG. 1 illustrates a high-level view of an exemplary 5G wireless network 100, which includes a Next Generation Radio Access Network (NG-RAN, 199) and a 5G Core (5GC, 198). The NG-RAN can include one or more gNodeB's (gNBs, e.g., 100, 150) connected to the 5GC via one or more NG interfaces (e.g., 102, 152). More specifically, the gNBs can be connected to one or more Access and Mobility Management Functions (AMFs) in the 5GC via respective NG-C interfaces and to one or more User Plane Functions (UPFs) in the 5GC via respective NG-U interfaces. Various other network functions (NFs) can be included in the 5GC, as described in more detail below.

In addition, the gNBs can be connected to each other via one or more Xn interfaces (e.g., 140 between gNBs 100, 150). The radio technology for the NG-RAN is often referred to as “New Radio” (NR). With respect to the NR interface to UEs, each of the gNBs can support frequency division duplexing (FDD), time division duplexing (TDD), or a combination thereof. Each of the gNBs can serve a geographic coverage area including one or more cells and, in some cases, can also use various directional beams to provide coverage in the respective cells.

The NG RAN logical nodes shown in FIG. 1 include a Centralized Unit (CU or gNB-CU) and one or more Distributed Units (DU or gNB-DU). CUs (e.g., 110) are logical nodes that host higher-layer protocols and perform various gNB functions such controlling the operation of DUs. In contrast, DUs (e.g., 120, 130) are decentralized logical nodes that host lower layer protocols and can include, depending on the functional split option, various subsets of the gNB functions. A CU connects to one or more DUs over respective F1 logical interfaces (e.g., 122, 132 in FIG. 1). However, the F1 interface is not visible outside of a gNB.

Another change in 5G networks (e.g., in 5GC) is that traditional peer-to-peer interfaces and protocols found in earlier-generation networks are modified and/or replaced by a Service Based Architecture (SBA) in which Network Functions (NFs) provide one or more services to one or more service consumers. This can be done, for example, by Hyper Text Transfer Protocol/Representational State Transfer (HTTP/REST) application programming interfaces (APIs). In general, the various services are self-contained functionalities that can be changed and modified in an isolated manner without affecting other services.

Furthermore, the services are composed of various “service operations”, which are more granular divisions of the overall service functionality. The 5G SBA model is based on principles including modularity, reusability and self-containment of NFs, which can enable network deployments to take advantage of the latest virtualization and software technologies.

Network function virtualization (NFV) is a network architecture concept that leverages traditional server-virtualization techniques used in enterprise information technology (IT) systems. A goal of NFV is to virtualize functionality conventionally deployed in network nodes into NF building blocks that can be used to create and deliver communication services. Virtual NFs (VNFs) can be implemented within one or more virtual machines (VMs) or containers (e.g., Kubernetes) running different software and processes, on top of commercial off-the-shelf (COTS) high-volume servers, switches, and storage devices or even on cloud computing infrastructure—in contrast to conventional deployments with custom hardware appliances for each NF. The term “NF virtualization infrastructure” (or NFVI) often refers to the collection of hardware and software that builds the environment where VNFs are deployed, which may span multiple physical locations.

The European Telecommunications Standards Institute (ETSI) includes an NFV Industry Specification Group (ISG) that has produce standards and specifications for various NFV aspects including functional architecture, information model, data model, protocols, application programming interfaces (APIs), testing, reliability, security, future evolution, etc. In particular, ETSI ISG NFV initiated work on Release 5 (Rel-5) of these specification in May 2021.

In ETSI terminology, a VNF descriptor (VNFD) is a configuration template that describes a VNF in terms of its deployment and operational behavior. A VNFD can be used during on-boarding and life-cycle management (LCM) of a VNF instance. A new feature in Rel-5 is “Flexible VNF deployment”, which introduces “deployable modules” in VNFDs. More specifically, a deployable module (DM) is a set of one or more Virtualization Deployment Units (VDUs), with each VDU associated with the deployment and operational behavior of a specific VNF component (VNFC). Contrary to conventional VNFCs, the VNFCs based on VDUs (and DMs) are not required to be instantiated.

Moreover, a VNF deployment flavor (DF) is a configuration that describes a specific deployment of a VNF (or a Network Service, NS) that meets and/or supports specific key performance indicators (KPIs) such as capacity, throughput, latency, reliability, etc. A VNF DF may contain one or more DMs, with each of the DMs associated with a set of one or more VDUs. By using VNF DFs, a single VNFD can be designed to support different deployment requirements and avoid the need to create multiple VNF packages. For example, DFs can address requirements for different VNF sizes (e.g., different VNFC scaling ranges and/or different VDU capacities) and topologies for multiple deployment scenarios with different needs. For example, a VNF might support a high availability configuration described in a first DF and a basic (or non-high availability) configuration described in a second DF, with the first DF including some VNFCs not included in the second DF.

When DMs are included in a VNF DF, the consumer of the VNF LCM interface can select which DMs are selected for any individual deployment. In such case, the only VNFCs to be instantiated for a deployment are the ones based on VDUs that are part of the selected DMs and/or based on mandatory VDUs (i.e., without DMs).

### SUMMARY

However, the use of DMs in VNF DFs can create various problems, issues, and/or difficulties. For example, a VNFC may have one or more external connection points (CPs, specifically “VnfExtCps”) that are used for establishing the external connectivity of the VNF. When a VNFC is included in a NS, an VnfExtCp may be connected to a NS virtual link (i.e., within the NS) or exposed as an external service access point (SAP) of the NS.

VDUs may also have CPs (“VduCps”) that can be used to establish external connectivity of a VNF. In other words, some VnfExtCps may be associated with DMs because they are exposing VduCps of corresponding VDUs. As such, the number of VnfExtCps that a VNF exposes may be affected by the selection of DMs done by the VNF LCM consumer. If VnfExtCps associated with DMs are re-exposed as SAPs, an entity that establishes the external connectivity of the NS must be aware of how the SAPs are related to DMs of the constituent VNFCs of the NS, which may change from deployment to deployment. This is undesirable and in some cases may not even be feasible.

An object of embodiments of the present disclosure is to facilitate flexible VNF deployment using DMs that are selectable according to deployment needs.

Some embodiments of the present disclosure include methods (e.g., procedures) for deploying network services (NS) based on one or more virtualized network functions (VNFs) available in a communication network (e.g., 5GC).

These exemplary methods include obtaining a first NSD of a first NS. The first NSD includes the following: an identifier of a VNF descriptor (VNFD) of a constituent VNF of the NS, and a first service access point descriptor (SAPD) of a first SAP of the NS. The first SAPD includes the following attributes associated with the first SAP: an identifier of VNFD as a constituent element of the first SAP, an identifier of a first connection point (CP) of the VNFD, and a first mapping between the first CP and a first deployable module (DM) of the constituent VNF.

In some embodiments, the constituent VNF includes a plurality of virtualization deployment units (VDUs) that are not required to be included in instantiations of the constituent VNF. The VNFD indicates a first one of the VDUs that is associated with the first DM of the constituent VNF. The first VDU includes the first CP, which the VNFD indicates as an external CP for the constituent VNF.

In some embodiments, these exemplary methods also include determining one or more of the following first information based on the first SAPD of the first NSD: that the first DM has been instantiated, that the first CP has been instantiated, and that external connectivity is needed for the first SAP. In some of these embodiments, the first information is determined based on the first SAPD without accessing the VNFD of the constituent VNF.

In some embodiments, the first NSD also includes an identifier of the first DM of the constituent VNF. In some of these embodiments, the identifier of the first DM (i.e., in the first NSD) includes a qualifier associated with the VNFD of the constituent VNF.

In some embodiments, these exemplary methods also include deploying the first NS in the communication network, in accordance with the obtained first NSD.

In other embodiments, the first NS is nested in a composite NS and the first NSD is obtained as part of a second NSD for the composite NS. The second NSD includes an identifier of the first NSD and a second SAPD of a second SAP of the composite NS. The second SAPD includes the following attributes associated with the second SAP: an identifier of the first NSD as a constituent element, an identifier of the first SAPD, and a second mapping between the first SAPD and the first DM.

In some of these embodiments, these exemplary methods also include determining one or more of the following second information based on the second SAPD in the second NSD: that the first DM has been instantiated, that the first SAP has been instantiated, and that external connectivity is needed for the second SAP. In some variants of these embodiments, the second information is determined based on the second SAPD without accessing the first NSD.

In some of these embodiments, the second NSD also includes an identifier of the first DM of the constituent VNF. In some variants of these embodiments, the identifier of the first DM (i.e., in the second NSD) includes qualifiers associated with the following: the VNFD of the constituent VNF, and the first NSD.

In some of these embodiments, these exemplary methods also include deploying the second NS in the communication network, in accordance with the obtained second NSD.

In some embodiments, the method is performed by one of the following associated with the communication network: a NFV management and orchestration (MANO) function, an operations support system (OSS), and a business support system (BSS).

Other embodiments include network management functions configured to perform the operations corresponding to any of the exemplary methods described herein, and network equipment arranged to implement such network management functions. Other embodiments also include non-transitory, computer-readable media storing computer-executable instructions that, when executed by processing circuitry associated with such network management functions, configure the same to perform operations corresponding to any of the exemplary methods described herein.

These and other embodiments described herein may provide various benefits and/or advantages, for example, embodiments may enable an entity in charge of establishing external connectivity of a NS to be aware of SAPs exposed by the NS in a particular deployment based on the selected DMs of the NS constituents, without having to access descriptors of the NS constituents. Put differently, to compile mapping information of SAPs of NS constituents, an NSD designer only needs to have access to the descriptors of the direct children of the NS. This may be particularly beneficial since, in general, access to descriptors of the NSD constituents may not be possible or feasible. Accordingly, embodiments may facilitate flexible VNF deployment using DMs that are selectable according to deployment needs.

These and other objects, features, and advantages of the present disclosure will become apparent upon reading the following Detailed Description in view of the Drawings briefly described below.

### BRIEF DESCRIPTION OF THE DRAWINGS

FIGS. 1-2 illustrate various aspects of an exemplary 5G network architecture.

FIG. 3 shows a block diagram representation of a generic network service descriptor (NSD) structure.

FIG. 4 shows an exemplary VNF DF including different VDUs associated with various VNFCs of the VNF.

FIG. 5 shows an example VNFD that includes a particular VDU shown in FIG. 4.

FIGS. 6-7 illustrate two examples of how the VNFD shown in FIG. 5 may be included in an NSD.

FIG. 8 shows an example of the NSD in FIG. 7 can be nested in a composite NSD, according to some embodiments of the present disclosure.

FIG. 9 shows an exemplary method (e.g., procedure) for deploying NS based on one or more VNFs available in a communication network, according to various embodiments of the present disclosure.

FIG. 10 shows a communication system according to various embodiments of the present disclosure.

FIG. 11 shows a network node according to various embodiments of the present disclosure.

FIG. 12 shows host computing system according to various embodiments of the present disclosure.

FIG. 13 is a block diagram of a virtualization environment in which functions implemented by some embodiments of the present disclosure may be virtualized.

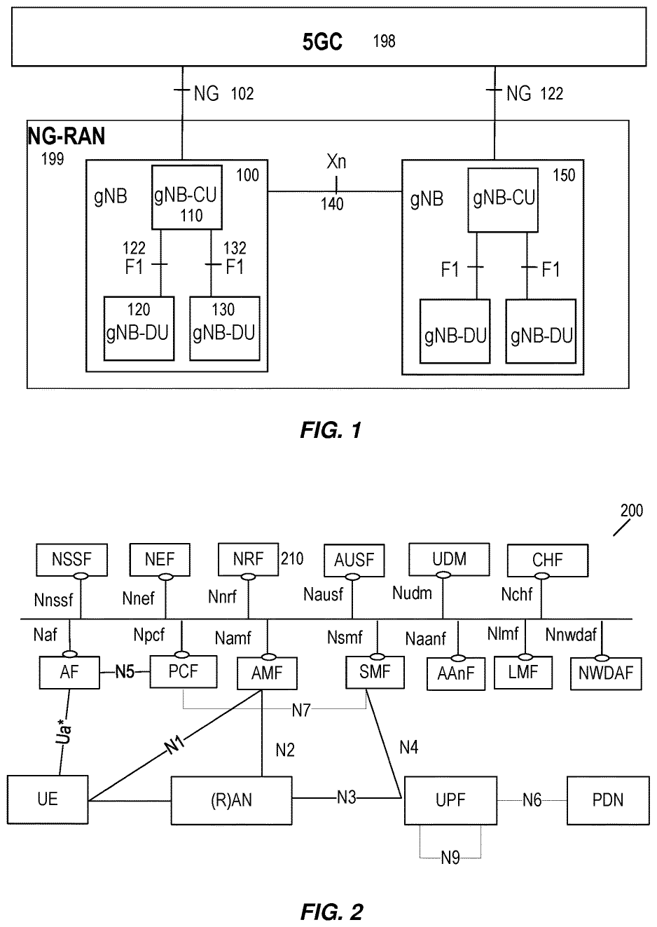

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, operation, etc., unless explicitly stated otherwise. The operations of any methods and/or procedures disclosed herein do not have to be performed in the exact order disclosed, unless an operation is explicitly described as following or preceding another operation and/or where it is implicit that an operation must follow or precede another operation. Any feature of any of the embodiments disclosed herein can be applied to any other embodiment, wherever appropriate. Likewise, any advantage of any of the disclosed embodiments can apply to any other disclosed embodiment. Other objects, features and advantages of the disclosed embodiments will be apparent from the following description.

FIG. 2 shows an exemplary non-roaming reference architecture for a 5G network (200). These include the following 3GPP-defined NFs and service-based interfaces:
Application Function (AF, with Naf interface) interacts with the 5GC to provision information to the network operator and to subscribe to certain events happening in operator's network. An AF offers applications for which service is delivered in a different layer (i.e., transport layer) than the one in which the service has been requested (i.e., signaling layer), the control of flow resources according to what has been negotiated with the network. An AF communicates dynamic session information to PCF (via N5 interface), including description of media to be delivered by transport layer.
Policy Control Function (PCF, with Npcf interface) supports unified policy framework to govern the network behavior, via providing PCC rules (e.g., on the treatment of each service data flow that is under PCC control) to the SMF via the N7 reference point. PCF provides policy control decisions and flow based charging control, including service data flow detection, gating, QoS, and flow-based charging (except credit management) towards the SMF. The PCF receives session and media related information from the AF and informs the AF of traffic (or user) plane events.
User Plane Function (UPF)—supports handling of user plane traffic based on the rules received from SMF, including packet inspection and different enforcement actions (e.g., event detection and reporting). UPFs communicate with the RAN (e.g., NG-RNA) via the N3 reference point, with SMFs (discussed below) via the N4 reference point, and with an external packet data network (PDN) via the N6 reference point. The N9 reference point is for communication between two UPFs.
Session Management Function (SMF, with Nsmf interface) interacts with the decoupled traffic (or user) plane, including creating, updating, and removing Protocol Data Unit (PDU) sessions and managing session context with the User Plane Function (UPF), e.g., for event reporting. For example, SMF performs data flow detection (based on filter definitions included in PCC rules), online and offline charging interactions, and policy enforcement.
Charging Function (CHF, with Nchf interface) is responsible for converged online charging and offline charging functionalities. It provides quota management (for online charging), re-authorization triggers, rating conditions, etc. and is notified about usage reports from the SMF. Quota management involves granting a specific number of units (e.g., bytes, seconds) for a service. CHF also interacts with billing systems.
Access and Mobility Management Function (AMF, with Namf interface) terminates the RAN CP interface and handles all mobility and connection management of UEs (similar to MME in EPC). AMFs communicate with UEs via the N1 reference point and with the RAN (e.g., NG-RAN) via the N2 reference point.
Network Exposure Function (NEF) with Nnef interface—acts as the entry point into operator's network, by securely exposing to AFs the network capabilities and events provided by 3GPP NFs and by providing ways for the AF to securely provide information to 3GPP network. For example, NEF provides a service that allows an AF to provision specific subscription data (e.g., expected UE behavior) for various UEs.
Network Repository Function (NRF, 210) with Nnrf interface—provides service registration and discovery, enabling NFs to identify appropriate services available from other NFs.
Network Slice Selection Function (NSSF) with Nnssf interface—a “network slice” is a logical partition of a 5G network that provides specific network capabilities and characteristics, e.g., in support of a particular service. A network slice instance is a set of NF instances and the required network resources (e.g., compute, storage, communication) that provide the capabilities and characteristics of the network slice. The NSSF enables other NFs (e.g., AMF) to identify a network slice instance that is appropriate for a UE's desired service.
Authentication Server Function (AUSF) with Nausf interface—based in a user's home network (HPLMN), it performs user authentication and computes security key materials for various purposes.
Network Data Analytics Function (NWDAF) with Nnwdaf interface—provides network analytics information (e.g., statistical information of past events and/or predictive information) to other NFs on a network slice instance level.
Location Management Function (LMF) with Nlmf interface—supports various functions related to determination of UE locations, including location determination for a UE and obtaining any of the following: DL location measurements or a location estimate from the UE; UL location measurements from the NG RAN; and non-UE associated assistance data from the NG RAN.
Unified Data Management (UDM) function with Nudm interface—supports generation of 3GPP authentication credentials, user identification handling, access authorization based on subscription data, and other subscriber-related functions. To provide this functionality, the UDM uses subscription data (including authentication data) stored in the 5GC unified data repository (UDR). In addition to the UDM, the UDR supports storage and retrieval of policy data by the PCF, as well as storage and retrieval of application data by NEF.

The services provided by the various NFs are composed of “service operations”, which are more granular divisions of the overall service functionality. The interactions between service consumers and producers can be of the type “request/response” or “subscribe/notify”. In the latter type, a service consumer NF (or equivalently, “service consumer NF”) requests a service producer NF (or equivalently, “service producer NF”) to establish a subscription for the service consumer NF to receive notifications from the service producer NF under conditions specified in this subscription.

It is expected that network function virtualization (NFV) will be an important enabler for 5G SBA deployments. As mentioned above, NFV leverages traditional server-virtualization techniques used in enterprise IT systems, with a goal of virtualizing functionality conventionally deployed in network nodes into NF building blocks that may be used to create and deliver communication services. Virtual NFs (VNFs) may be implemented within one or more virtual machines (VMs) or containers (e.g., Kubernetes) running different software and processes, on top of COTS high-volume servers, switches, and storage devices or even on cloud computing infrastructure—in contrast to conventional deployments with custom hardware appliances for each NF. The term “NF virtualization infrastructure” (or NFVI) often refers to the collection of hardware and software that builds the environment where VNFs are deployed, which may span multiple physical locations.

The ETSI NFV ISG produces standards and specifications for various NFV aspects including functional architecture, information model, data model, protocols, APIs, testing, reliability, security, future evolution, etc. ETSI NFV ISG initiated work on Rel-5 of these specification in May 2021.

In ETSI terminology, a network service (NS) is a composition of NF(s) and/or other Network Service(s), defined by its functional and behavioral specification. A NS contributes to behavior of higher layer services that run on top of it, which can be characterized in terms of performance, dependability, and security. The end-to-end NS behavior is the result of the combination of individual NF behaviors with behaviors of the network infrastructure.

Put differently, a NS is a composition NFs arranged as a set of functions with unspecified connectivity between them, e.g., according to one or more forwarding graphs. A Network Service Descriptor (NSD) is a deployment template which includes information that can be used by a NFV Orchestrator (NFVO) for life cycle management (LCM) of instances of a NS in a communication network. For example, a NSD can be used by NFV Management and Orchestration (MANO) functions (including NFVO) to deploy instances of the described NS. At a high level, an NSD includes service topology and characteristics, including any relevant service-level agreements (SLAs) and/or other information necessary for NS on-boarding and LCM of NS instances.

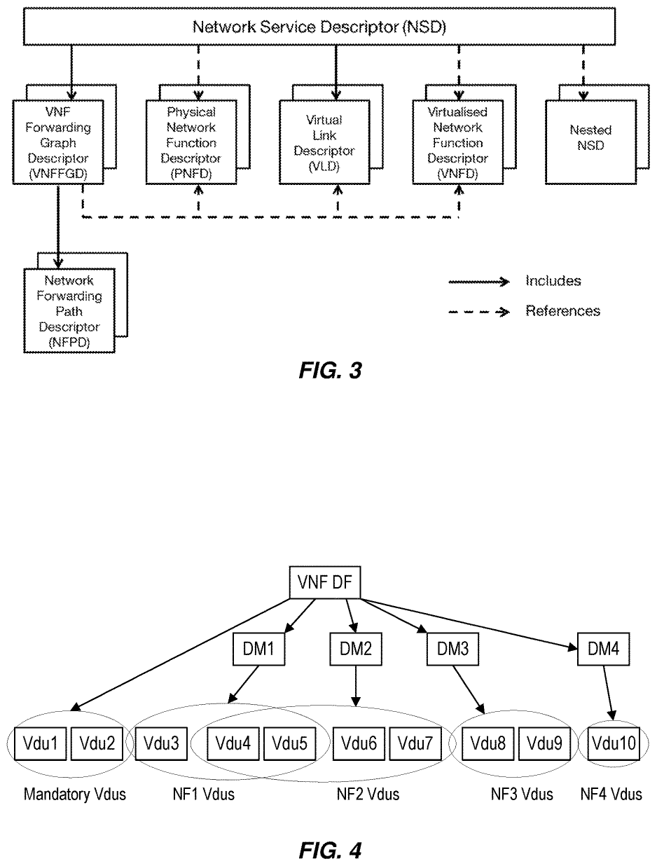

FIG. 3 shows a block diagram representation of a generic NSD structure, which includes the following constituent objects:
zero, one, or multiple VNF Descriptors (VNFDs), which are configuration templates that describe VNFs in terms of their respective deployment and operational behaviors, and are used during on-boarding and LCM of VNF instances;
zero, one, or multiple Virtual Link Descriptors (VLD) used by NFVO to deploy Virtual Links (VL) within the NS;
zero, one, or multiple Physical Network Function Descriptor (PNFD) used by NFVO to determine how to connect PNFs to VLs in the NS;
zero, one, or multiple nested NSD(s); and
zero, one, or multiple VNF Forwarding Graph Descriptors (VNFFGDs), each of which describes a topology of the NS or a portion of the NS, by referencing a pool of connection points and service access points (SAPs), the descriptors of its constituent VNFs, PNFs, and the VLs that connect them, and optionally one or more Network Forwarding Path (NFP) descriptors.

Note that the information in a PNFD is limited to the description of connectivity requirements to integrate PNFs in an NS. Also, an NSD must reference at least one VNFD or at least one nested NSD. Also, a NSD may contain different VNFFGDs, with each VNFFGD using subsets of the VLDs, VNFDs, and PNFDs included in the NSD. These different VNFFGs can result in packets/frames traversing identical sequences of (V) NFs, depending on the NFP descriptors included in the VNFFGDs. In each VNFFG, the connectivity topology represents how the (V) NFs among which packets/frames can be exchanged are connected to each other. A Network Connectivity Topology (NCT) represents a higher logical level connectivity, possibly a global view of combined connectivity from different VNFFGs of a given NS.

As noted above, NS may be nested. An SAP of a nested NS may be connected to a NS virtual link of the composite NS or may be in turn exposed also as an SAP of the composite NS to establish the external connectivity of the composite NS.

A new feature in Rel-5 is “Flexible VNF deployment”, which introduces “deployable modules” in VNFDs. More specifically, a deployable module (DM) is a set of one or more Virtualization Deployment Units (VDUs), with each VDU associated with the deployment and operational behavior of a specific VNF component (VNFC). Contrary to conventional VNFCs, the VNFCs based on VDUs (and DMs) are not required to be instantiated.

A VNF deployment flavor (DF) is a configuration that describes a specific deployment of a VNF that meets/supports specific key performance indicators (KPIs) such as capacity, throughput, latency, reliability, etc. The deployment of an optional set of VNFCs within the full set that constitutes a VNF can realized by an intermediary grouping level between the VNF DF level and the VDU level. An optional set of VNFCs has the following characteristics:
a set is specified in the VNFD per VNF DF, i.e., as a design time decision;
a set consists of one or multiple VNFCs;
each VNFC is part of zero, one, or multiple sets;
sets are independent, such that any decision to deploy a set is independent of other sets;
from VNF perspective, the decision whether to deploy an optional set is taken at run time.

More specifically, a VNF DF may contain one or more DMs, with each of the DMs associated with a set of one or more VDUs. By using VNF DFs, a single VNFD can be designed to support different deployment requirements and avoid the need to create multiple VNF packages. For example, a VNF DF can support requirements for different VNF sizes (e.g., different VNFC scaling ranges and/or VDUs of different capacities) and topologies for multiple deployment scenarios with different needs. As a more specific example, a VNF might support a high availability configuration described in a first DF and a basic (non-high availability) configuration described in a second DF, with the first DF including some VNFCs not included in the second DF.

When DMs are included in a VNF DF, the consumer of the VNF LCM interface can select which DMs are selected for any individual deployment. In such case, the only VNFCs to be instantiated for a deployment are the ones based on VDUs that are part of the selected DMs and/or based on mandatory VDUs (i.e., without DMs).

FIG. 4 shows an exemplary VNF DF including different VDUs associated with various VNFCs of the VNF. In particular, Vdu1 and Vdu2 are mandatory such that the VNFCs based on these VDUs will be instantiated in all deployments of the VNF in a NS (with the possible exception when a scale level with 0 instances for that VNFC is defined). The selection of DM1 results in the instantiation of NF1 including Vdu3, Vdu4, and Vdu5, while the selection of DM2 results in the instantiation of NF2 including Vdu4, Vdu5, Vdu6, and Vdu7. Similarly, the selection of DM3 results in the instantiation of Vdu8 and Vdu9, while the selection of DM4 results in the instantiation of Vdu10. In FIG. 4, Vdu4 and Vdu5 are associated with multiple DMs while each of the other VDUs is associated with only one DM.

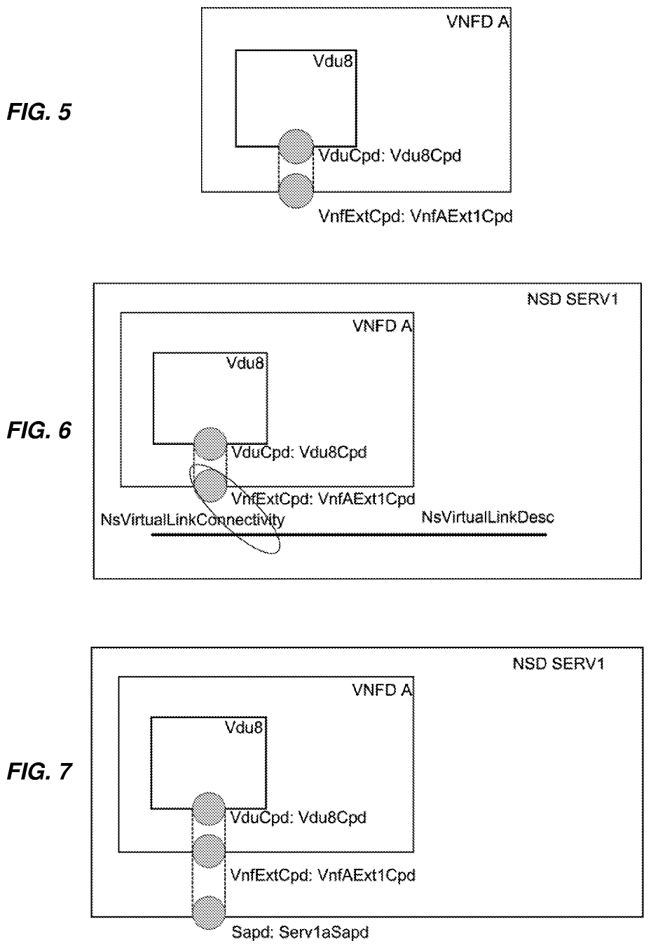

A VNFC may have one or more external connection points (CPs, specifically “VnfExtCps”) that are used to establish external connectivity of the VNF. VDUs may also have CPs (“VduCps”) that can be used to establish external connectivity of a VNF. FIG. 5 shows an example VNFD “A” that includes Vdu8 of FIG. 4. Vdu8 has a VduCpd called Vdu8Cpd that is exposed as a VnfExtCpd called VnfAExt1Cpd. Other VDUs shown in FIG. 4 may be included in the VNFD shown in FIG. 5 with VduCps exposed in a similar manner, but are omitted for brevity and/or simplicity.

The introduction of DMs implies that the number of VnfExtCps that a VNF exposes may be affected by the selection of DMs performed during VNF LCM by the NFVO. The NFVO needs to be aware of the VnfExtCps in order to establish external connectivity of the VNF, e.g., by assigning Internet Protocol (IP) addresses for the VnfExtCps.

FIG. 6 illustrates one example of how VNFD A shown in FIG. 5 may be included in a NSD, such as illustrated in FIG. 3. In particular, VNFD A is included in a NSD for a NS called SERV1. In this example, VnfAExt1Cp of VNFD A is connected to a NsVirtualLink, which is specified in a VLD called NSVirtualLinkDesc. For example, this connectivity can be defined with an information element (IE) in the NSD called NsVirtualLinkConnectivity.

During LCM of VNF A, the NFVO will select which DMs of VNF A are to be deployed. This may be based on a selection specified in the NSD of NS SERV1, on information provided via the user of the NS LCM interface, or on information provided via some user interface in the NFVO. If DM3 is selected, the VNFC based on Vdu8 will be deployed and VnfAExt1Cp will be instantiated. Since the NFVO has access to VNFD A in the NSD of SERV1, it is aware that VnfAExt1Cp will be instantiated but does not need to establish external connectivity for it.

However, if VnfAExt1Cp of VNFD A were instead exposed as an SAP for SERV1, the entity that establishes the external connectivity of a NS would need to be aware of how the SAPs are related to deployable modules of the NS constituents. FIG. 7 illustrates another example of how VNFD A shown in FIG. 5 may be included in the NSD for a NS called SERV1. In this example, VnfAExt1Cp of VNFD A is not connected to a NsVirtualLink but rather used to provide external connectivity of the NS. In particular, VnfAExt1Cp of VNFD A is exposed as an external SAP of SERV1 called Serv1aSapd.

An entity that establishes the external connectivity of SERV1 would need to be aware of how the SAPs are related to deployable modules of the NS constituents. This is undesirable because that entity may be outside MANO, such as in an operations support system (OSS) or a business support systems (BSS), and should not be required to understand the details of NS constituents. Furthermore, as mentioned above, SERV1 may be used as a nested NS in a composite NS. In such case, the designer of the composite NSD may not have access to the VNFDs of the nested NSD.

Embodiments of the present disclosure address these and other problems, issues, and/or difficulties by providing novel, flexible, and efficient techniques to expose information in a NSD about how SAPs map to DMs of constituent VNFs, or of VNFs that are constituents of nested NSs. This is needed when an SAP is exposing (either directly or via one or more levels of nesting) a VnfExtCp that is associated with a DM/VDU Exposing such information is not required for SAP-exposed VnfExtCps that are associated with mandatory VDUs, since it is assumed that these VnfExtCps will always be instantiated.

Furthermore, when SAP-to-DM mapping information is provided in this manner, the NSD will also expose DM information about its constituents directly in the NSD IE. In this manner, when a NS is used as nested NS in a composite NS and the SAP of the nested NS is re-exposed as a SAP in the composite NS, the designer of the composite NS is aware of how the selected DMs impact the number of SAPs of the composite NS.

Embodiments of the present disclosure can provide various benefits and/or advantages, For example, embodiments can enable an entity (e.g., OSS, BSS, other non-MANO entity, a designer of a composite NSD where the NS is used as nested NS) in charge of establishing external connectivity of a NS to be aware of the SAPs exposed by the NS in a particular deployment based on the selected DMs of the NS constituents, without having to access and dig into the descriptors of the NS constituents. Put differently, to compile mapping information of SAPs of NS constituents, an NSD designer only needs to have access to the descriptors of the direct children of the NS. This may be particularly beneficial since, in general, access to descriptors of the NSD constituents may not be possible or feasible.

ETSI GS NFV-IFA 014 (v4.4.1) specifies a data structures for NSDs. In particular, an NSD IE is specified to include the attributes in Table 1 below.

TABLE 1

| Attribute | Qual. | Card. | Content | Description |
|---|---|---|---|---|
| nsdIdentifier | M | 1 | Identifier | Identifier of this NSD information element. |
| | | | | It Globally uniquely identifies an instance |
| | | | | of the NSD. |
| designer | M | 1 | String | Specifies the designer of the NSD. |
| version | M | 1 | Version | Specifies the version of the NSD. |
| nsdName | M | 1 | String | Provides the human readable name of the NSD. |
| nsdInvariantId | M | 1 | Identifier | Identifies an NSD in a version independent |
| | | | | manner. This attribute is invariant across |
| | | | | versions of NSD with no constraint on the |
| | | | | changes across versions. |
| | | | | See note 5. |
| nsdExtInvariantId | M | 0 . . . 1 | Identifier | Identifies an NSD in a version independent |
| | | | | manner. This attribute is invariant across |
| | | | | versions of the NSD that fulfil certain |
| | | | | conditions related to the external |
| | | | | connectivity and management of the NS. |
| | | | | See note 6. |
| nestedNsdId | M | 0 . . . N | Identifier | References the NSD of a constituent nested NS. |
| | | | (Reference to Nsd) | See note 1. |
| vnfdId | M | 0 . . . N | Identifier | References the VNFD of a constituent VNF. |
| | | | (Reference to Vnfd) | See note 1. |
| pnfdId | M | 0 . . . N | Identifier | References the PNFD of a constituent PNF. |
| | | | (Reference to Pnfd) | See note 1. |
| sapd | M | 0 . . . N | Sapd | Provides the descriptor of a service access |
| | | | | point of the network service. |
| virtualLinkDesc | M | 0 . . . N | NsVirtualLinkDesc | Provides the constituent VLDs. |
| | | | | See note 2. |
| vnffgd | M | 0 . . . N | Vnffgd | Provides the descriptors of the applicable |
| | | | | forwarding graphs. |
| | | | | See note 2. |
| autoScalingRule | M | 0 . . . N | Rule | Specifies a rule to trigger a scaling action on |
| | | | | an NS instantiated according to the NSD. |
| | | | | See notes 3 and 4. |
| lifeCycleManagementScript | M | 0 . . . N | LifeCycleManagementScript | Provides a life cycle management script |
| | | | | written in a Domain Specific Language |
| | | | | (DSL). |
| nsDf | M | 1 . . . N | NsDf | Specifies a DF within the scope of an NSD. |
| security | M | 1 | SecurityParameters | Provides a signature to prevent tampering. |
| strictNsdConstituentOnboarding | M | 0 . . . 1 | Boolean | Indicates if all NSD constituents referenced |
| | | | | by this NSD shall be onboarded before |
| | | | | onboarding the NSD identified by this |
| | | | | information element. Default (when the |
| | | | | attribute is not present) is True (all |
| | | | | referenced constituents shall be onboarded). |

NOTE 1:
At least one between nestedNsd and vnfdId attributes shall be present.
NOTE 2:
Cardinality of 0 means that the NS is a NF set with unspecified connectivity.
NOTE 3:
The rule is based on a combination of assertions on the values of virtualised resource-related performance metrics and VNF Indicators identified by the monitoredInfo attribute of the NsDf from which the NS instance is created.
NOTE 4:
There may be multiple data sources per rule, each corresponding to a different monitoredInfo attribute occurrence of the NsDf from which the NS instance is created.
NOTE 5:
The association of an NSD to an existing NS instance can be changed upon the condition that both NSDs have the same nsdInvariantId.
NOTE 6:
Different versions of an NSD have different nsdIds but can have the same nsdExtInvariantId. Different versions of the NSD with the same nsdExtInvariantId shall expose:
same external connectivity, i.e. same number of SAPDs and same identifiers;
same NSD attributes used in a composite NSD when referring to this NSD as nested NS:
NS deployment flavours and NS instantiation levels: in both cases the identifiers and the number of them shall be the same, but the content of e.g. a particular deployment flavour can change.
NsScaleInfo: same NsScalingAspects identifiers and same NsLevels identifiers per NsScalingAspect.
This condition implies that NSDs with the same nsdExtInvariantId preserve external invariancy. Therefore, fulfilling this condition allows to use a different version of a nested NSD in a composite NS instance without modification of the NSD on which the composite NS instance is based. The use of a different version of the nested NSD is ultimately under the control of the service provider of the composite NS and it should consider if the composite NSD fulfils the requirements of the SAPDs of the nested NSD (e.g. bitrate, IP version, etc.).

One of the attributes in the above is Service Access Point Descriptors (SAPD), which provides descriptors of SAPs of the NS. For each SAP, SAPD include the attributes listed in Table 2 below.

TABLE 2

| Attribute | Qual. | Card. | Content | Description |
|---|---|---|---|---|
| nsVirtualLinkDescId | M | 0 . . . 1 | Identifier | References the descriptor of the NS |
| | | | (Reference to | VL instance to which the SAP |
| | | | NsVirtualLinkDesc) | instantiated from this SAPD connects |
| | | | | to. See note. |
| associatedCpd | M | 0 . . . 1 | CpdInConstituentElement | Describes CPD or SAPD in the |
| | | | | context of an NS constituent element, |
| | | | | which the SAPs instantiated from this |
| | | | | SAPD are mapped to. See note. |
| (inherited | | | | All attributes inherited from |
| attributes) | | | | corresponding Cpd. |

NOTE:
At most one of the two attributes associatedCpd and nsVirtualLinkDescId shall be included.

The associatedCpd attribute in the table above references a CPD in a NSD constituent element (e.g., VNFD, nested NSD, or PNFD) that the SAP re-exposes. Depending on the type of the constituent element, the SAP may re-expose a VnfExtCp of a VNF, a PnfExtCp of a PNF, or an SAP of a nested NS. The associatedCpd attribute is of type CpdInConstituentElement. Some embodiments of the present disclosure include an enhanced CpdInConstituentElement data structure that includes available mapping information for DMs of the NS constituent elements, denoted by the cpToDeployableModuleMapping attribute in the Table 3 below.

TABLE 3

| Attribute | Qual. | Card. | Content | Description |
|---|---|---|---|---|
| constituentBaseElementId | M | 1 | Identifier | References the profile of an NS |
| | | | (Reference to | constituent. |
| | | | VnfProfile or | |
| | | | PnfProfile or | |
| | | | NsProfile) | |
| constituentCpdId | M | 1 | Identifier | References the VNF external CPD for |
| | | | (Reference to | a given VnfProfile, or the PNF |
| | | | VnfExtCpd or | external CPD for a given PnfProfile, |
| | | | PnfExtCpd or Sapd) | or an NS SAPD for a given NsProfile |
| | | | | identified by the |
| | | | | constituentBaseElementId. |
| cpToDeployableModuleMapping | | 0 . . . N | String | If the constituentCpdId is a reference |
| | | | | to a VnfExtCpd, the content of the |
| | | | | string is an identifier of a |
| | | | | deployableModule as defined in the |
| | | | | VNFD of the constituent VNF, to |
| | | | | which the VnfExtCpd is associated, if |
| | | | | any. If the VnfExtCpd is not |
| | | | | associated to any deployableModule, |
| | | | | the attribute shall not be present. |
| | | | | If the constituentCpdId is a reference |
| | | | | to a Sapd in a nested NS, the content |
| | | | | of the string is the value of a |
| | | | | ‘deployableModuleInConstituent’ |
| | | | | attribute, as defined in the nested |
| | | | | NSD, that identifies a |
| | | | | deployableModule to which the Sapd |
| | | | | in the nested NS is associated, if any. |
| | | | | If the Sapd in the nested NS is not |
| | | | | associated to any deployableModule, |
| | | | | this attribute shall not be present. |
| | | | | If the constituentCpdId is a reference |
| | | | | to a PnfExtCpd, the attribute shall not |
| | | | | be present. |
| | | | | See notes 1, 2 and 3. |

NOTE 1:
This attribute allows to determine the number of SAPs exposed in a concrete NS deployment scenario, depending on the selected deployable modules of the NS constituents, without requiring access to the descriptors of the NS constituents, i.e. VNFDs or nested NSDs. Potential users of this information are entities responsible to configure the external connectivity of the NS, including designers of a composite NSD where this NSD is used as nested.
NOTE 2:
Cardinalities greater than 1 are applicable when the VnfExtCp or the SAP in the nested NS is associated to more than one deployableModule.
NOTE 3:
When this attribute is present, the deployableModuleInConstituent attribute in the NSD information element shall also be present.

In some embodiments, the NSD data structure in Table 1 above can be enhanced to include the following attribute:

| Attribute | Qual. | Card. | Content | Description |
|---|---|---|---|---|
| deployableModuleInConstituent | | 0 . . . N | Identifier | Indicates a deployable module of a constituent |
| | | | | VNF or of a VNF of a constituent nested NS. |
| | | | | It shall only be present when an SAP defined |
| | | | | in the NSD exposes a VnfExtCp or an SAP of |
| | | | | a nested NS that is associated to a |
| | | | | deployableModule. |
| | | | | The content of the string shall include the |
| | | | | deployableModule identifier preceded by a |
| | | | | VnfProfile identifier and, if applicable, one or |
| | | | | more nested NsProfile identifiers. |
| | | | | See notes x, y. |

NOTE x:
Multiple NsProfile identifiers are applicable if there are more than one level of nesting.
NOTE y:
The purpose of this attribute is to allow a designer of a composite NSD in which this NSD is used as nested to populate the cpToDeployableModuleMapping attribute in the CpdInConstituentElement information element, if needed.

The new attribute above enables recursive exposure of the DM information. For example, it may indicate DMs of a VNF that is a constituent of a nested NS of a NS, which in turn, is also a nested NS of this NS. To populate this attribute, the NSD designer needs to have access to the descriptors of direct constituents (i.e., VNFDs, nested NSDs) of the NSD but does not need access to descriptors of VNFDs that are constituents of the direct constituents (or indirect constituents of the NSD).

Consider the example NSD shown in FIG. 7, in which VnfAExt1Cp is used to provide external connectivity of the NS. Thus, how VnfAExt1Cp is connected is determined outside the NSD and, in principle, outside of the MANO function in the network. When embodiments of the present disclosure are used, the associatedCpd attribute of the Serv1aSapd includes mapping information for DM3, which corresponds to Vdu8 of VNFD A which is a constituent of NSD SERV1. For example, the associatedCpd attribute of VnfAExt1Cpd re-exposed as SAPD Serv1aSapd includes the following (sub-)attributes:
constituentBaseElementId: VnfProfileId of VNF_A
constituentCpdId: VnfAExt1Cpd
cpToDeployableModuleMapping: DM3
   Based on this information included in the NSD, an entity in charge of establishing the external connectivity of the NS can determine which DMs have been selected, whether Serv1aSapd is instantiated, and whether connectivity for that SAP is expected.

In the example shown in FIG. 7, there is an SAP in the NS that is exposing a VnfExtCp that is associated with a DM. According to embodiments of the present disclosure, the NSD will also include an attribute exposing the DM identifier along with the identifier of the VnfProfile. For example, the NSD for SERV1 in FIG. 7 includes the following attribute:
deployableModuleInConstituent: “VnfAProfileId:DM3”
   Note that this attribute is included for the sole purpose of a composite NSD that uses SERV1 as nested NS, and that re-exposes the SAP as SAP of the composite NS. FIG. 8 shows an example where the NSD SERV1 from FIG. 7 is used as nested NSD in a composite NSD called COMP, and the SAP Serv1Sapd is also re-exposed as an SAP in the composite NS, i.e., Comp1aSapd.

Since the SAP of the nested NS is re-exposed, embodiments of the present disclosure can be used to enhance NSD COMP in a similar way as used to enhance NSD SERV1 in the previous example shown in FIG. 7. In particular, the associatedCpd attribute of NS COMP SAP Comp1aSapd will now include mapping information for DMs of VNF A that is a constituent of nested NS SERV1. For example, the associatedCpd attribute of the NSD for COMP can include the following (sub-)attributes:
constituentBaseElementId: NsdProfileId of NSD COMP
constituentCpdId: Serv1aSapd
cpToDeployableModuleMapping: VnfAProfileId:DM3
   Note that the DM identifier includes VNF constituent as a qualifier. This was defined in the deployableModuleInConstituent attribute of the NSD of nested NS SERV1, as discussed above. Thus, the designer of NSD COMP does not need to have access to the VNFD A.

In some embodiments, the NSD information element in NSD COMP will also expose the relevant DM (i.e., DM3) of VNF A, since that DM is associated with a VnfExtCpd in VNF A that is re-exposed as an SAP in NS COMP. For example, NSD COMP can include the following attribute:
deployableModuleInConstituent: “NsProfileSERV1Id:VnfAProfileId:DM3”

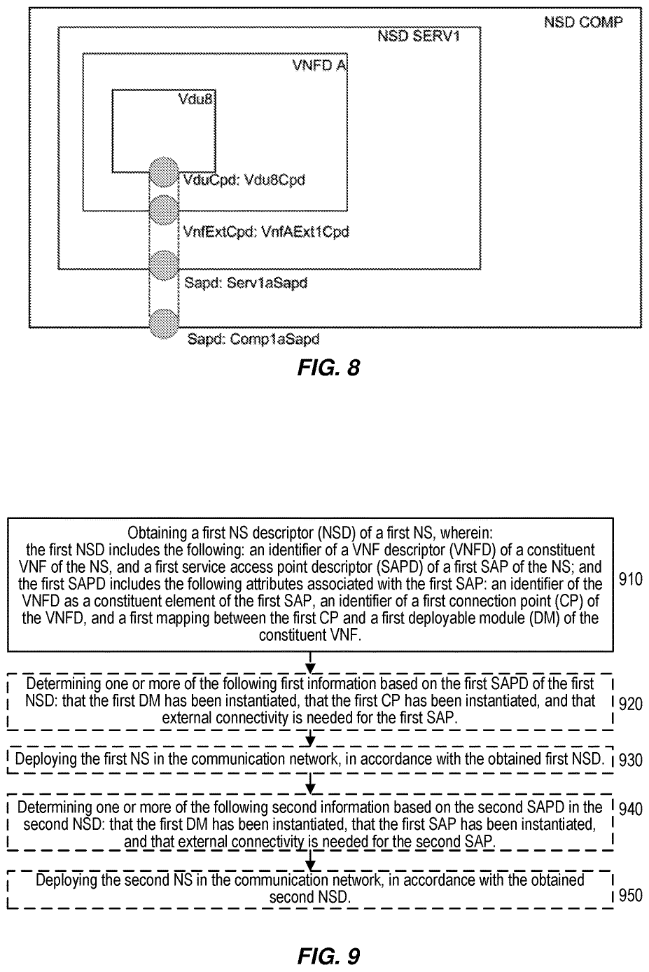

Various features of the embodiments described above correspond to various operations illustrated in FIG. 9, which depicts an exemplary method (e.g., procedure) for deploying network services (NS) based on one or more virtualized network functions (VNFs) available in a communication network, according to various embodiments of the present disclosure. In other words, various features of the operations described below correspond to various embodiments described above. Although FIG. 9 shows specific blocks in a particular order, the operations of the exemplary method can be performed in a different order than shown and can be combined and/or divided into blocks having different functionality than shown. Optional blocks or operations are indicated by dashed lines.

The following description is based on the exemplary method being performed by a network management function associated with the communication network. For example, the network management function can be implemented in a service management and orchestration (SMO) system for a RAN, as/in a NFV management and orchestration (MANO) function, in network management node(s) in OAM/OSS/BSS systems, or as an application running in a host computing system external to the network (e.g., public or private cloud environment).

The exemplary method includes the operations of block 910, where the network management function obtains a first NSD of a first NS. The first NSD includes the following: an identifier of a VNF descriptor (VNFD) of a constituent VNF of the NS, and a first service access point descriptor (SAPD) of a first SAP of the NS. The first SAPD includes the following attributes associated with the first SAP: an identifier of VNFD as a constituent element of the first SAP, an identifier of a first connection point (CP) of the VNFD, and a first mapping between the first CP and a first deployable module (DM) of the constituent VNF.

In some embodiments, the constituent VNF includes a plurality of virtualization deployment units (VDUs) that are not required to be included in instantiations of the constituent VNF. The VNFD indicates a first one of the VDUs that is associated with the first DM of the constituent VNF. The first VDU includes the first CP, which the VNFD indicates as an external CP for the constituent VNF.

In some embodiments, the exemplary method also includes the operations of block 920, where the network management function determines one or more of the following first information based on the first SAPD of the first NSD: that the first DM has been instantiated, that the first CP has been instantiated, and that external connectivity is needed for the first SAP. In some of these embodiments, the first information is determined based on the first SAPD without accessing the VNFD of the constituent VNF. FIG. 7 shows an example of these embodiments.

In some embodiments, the first NSD also includes an identifier of the first DM of the constituent VNF. In some of these embodiments, the identifier of the first DM (i.e., in the first NSD) includes a qualifier associated with the VNFD of the constituent VNF.

In some embodiments, the exemplary method also includes the operations of block 930, where the network management function deploys the first NS in the communication network, in accordance with the obtained first NSD.

In other embodiments, the first NS is nested in a composite NS and the first NSD is obtained as part of a second NSD for the composite NS. The second NSD includes an identifier of the first NSD and a second SAPD of a second SAP of the composite NS. The second SAPD includes the following attributes associated with the second SAP: an identifier of the first NSD as a constituent element, an identifier of the first SAPD, and a second mapping between the first SAPD and the first DM. FIG. 8 shows an example of these embodiments.

In some of these embodiments, the exemplary method also includes the operations of block 940, where network management function determines one or more of the following second information based on the second SAPD in the second NSD: that the first DM has been instantiated, that the first SAP has been instantiated, and that external connectivity is needed for the second SAP. In some variants of these embodiments, the second information is determined based on the second SAPD without accessing the first NSD.

In some of these embodiments, the second NSD also includes an identifier of the first DM of the constituent VNF. In some variants of these embodiments, the identifier of the first DM (i.e., in the second NSD) includes qualifiers associated with the following: the VNFD of the constituent VNF, and the first NSD.

In some of these embodiments, the exemplary method also includes the operations of block 950, where network management function deploys the second NS in the communication network, in accordance with the obtained second NSD.

In some embodiments, the method is performed by one of the following associated with the communication network: a NFV management and orchestration (MANO) function, an operations support system (OSS), and a business support system (BSS).

Although various embodiments are described herein above in terms of methods, apparatus, devices, computer-readable medium and receivers, the person of ordinary skill will readily comprehend that such methods can be embodied by various combinations of hardware and software in various systems, communication devices, computing devices, control devices, apparatuses, non-transitory computer-readable media, etc.

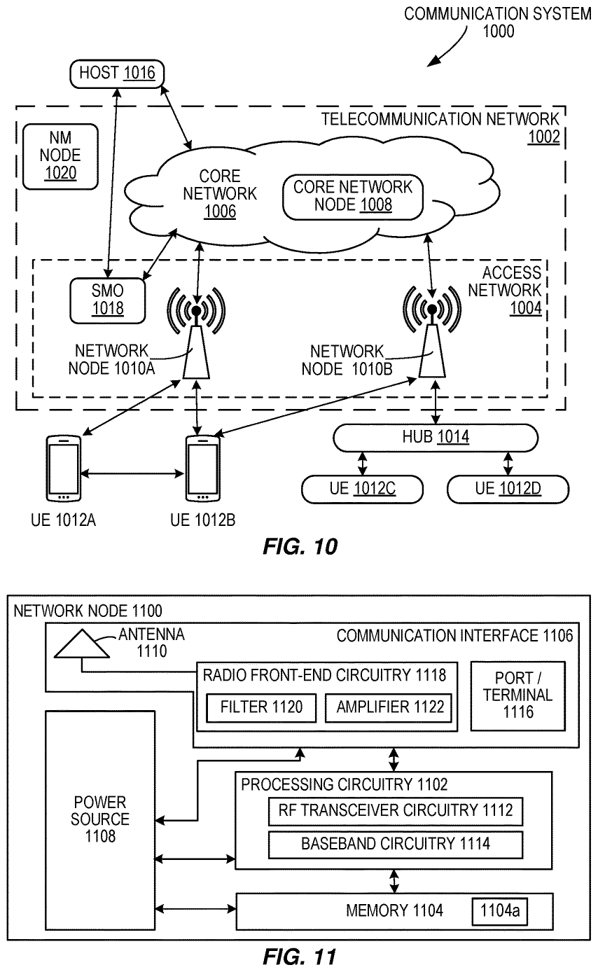

FIG. 10 shows an example of a communication system 1000 in accordance with some embodiments. In this example, communication system 1000 includes a telecommunication network 1002 that includes an access network 1004 (e.g., RAN) and a core network 1006, which includes one or more core network nodes 1008. In some embodiments, telecommunication network 1002 can also include one or more Network Management (NM) nodes 1018, which can be part of an operation support system (OSS), a business support system (BSS), and/or an OAM system. The NM nodes can monitor and/or control operations of other nodes in access network 1004 and core network 1006. Although not shown in FIG. 10, NM node 1018 is configured to communicate with other nodes in access network 1004 and core network 1006 for these purposes.

Access network 1004 includes one or more access network nodes, such as network nodes 1010a-b (one or more of which may be generally referred to as network nodes 1010), or any other similar 3GPP access node or non-3GPP access point. Network nodes 1010 facilitate direct or indirect connection of UEs, such as by connecting UEs 1012a-d (one or more of which may be generally referred to as UEs 1012) to core network 1006 over one or more wireless connections.

Moreover, as will be appreciated by those of skill in the art, a network node is not necessarily limited to an implementation in which a radio portion and a baseband portion are supplied and integrated by a single vendor. Thus, it will be understood that network nodes include disaggregated implementations or portions thereof. For example, in some embodiments, the telecommunication network 1002 includes one or more Open-RAN (ORAN) network nodes. An ORAN network node is a node in the telecommunication network QQ102 that supports an ORAN specification (e.g., a specification published by the O-RAN Alliance, or any similar organization) and may operate alone or together with other nodes to implement one or more functionalities of any node in the telecommunication network 1002, including one or more network nodes 1010 and/or core network nodes 1008.

Examples of an ORAN network node include an open radio unit (O-RU), an open distributed unit (O-DU), an open central unit (O-CU), including an O-CU control plane (O-CU-CP) or an O-CU user plane (O-CU-UP), a RAN intelligent controller (near-real time or non-real time) hosting software or software plug-ins, such as a near-real time control application (e.g., xApp) or a non-real time control application (e.g., rApp), or any combination thereof (the adjective “open” designating support of an ORAN specification). The network node may support a specification by, for example, supporting an interface defined by the ORAN specification, such as an A1, F1, W1, E1, E2, X2, Xn interface, an open fronthaul user plane interface, or an open fronthaul management plane interface. Moreover, an ORAN access node may be a logical node in a physical node. Furthermore, an ORAN network node may be implemented in a virtualization environment (described further below) in which one or more network functions are virtualized. For example, the virtualization environment may include an O-Cloud computing platform orchestrated by a Service Management and Orchestration Framework via an O-2 interface defined by the O-RAN Alliance or comparable technologies.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1000 may include any number of wired or wireless networks, network nodes, UEs, and/or any other components or systems that may facilitate or participate in the communication of data and/or signals whether via wired or wireless connections. Communication system 1000 may include and/or interface with any type of communication, telecommunication, data, cellular, radio network, and/or other similar type of system.

UEs 1012 may be any of a wide variety of communication devices, including wireless devices arranged, configured, and/or operable to communicate wirelessly with network nodes 1010 and other communication devices. Similarly, network nodes 1010 are arranged, capable, configured, and/or operable to communicate directly or indirectly with UEs 1012 and/or with other network nodes or equipment in telecommunication network 1002 to enable and/or provide network access, such as wireless network access, and/or to perform other functions, such as administration in telecommunication network 1002.

In the depicted example, core network 1006 connects network nodes 1010 to one or more hosts, such as host 1016. These connections may be direct or indirect via one or more intermediary networks or devices. In other examples, network nodes may be directly coupled to hosts. Core network 1006 includes one or more core network nodes (e.g., 1008) that are structured with hardware and software components. Features of these components may be substantially similar to those described with respect to the UEs, network nodes, and/or hosts, such that the descriptions thereof are generally applicable to the corresponding components of the core network node 1008. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

Host 1016 may be under the ownership or control of a service provider other than an operator or provider of the access network 1004 and/or telecommunication network 1002, and may be operated by the service provider or on behalf of the service provider. Host 1016 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

In some embodiments, access network 1004 can include a service management and orchestration (SMO) system or node 1020, which can monitor and/or control operations of the access network nodes 1010. This arrangement can be used, for example, when access network 1004 utilizes an Open RAN (O-RAN) architecture. SMO system 1020 can be configured to communicate with core network 1006 and/or host 1016, as shown in FIG. 10.

In some embodiments, one or more of host 1016, network management node 1018, and SMO system 1020 can be configured to perform various operations of exemplary methods (e.g., procedures) for deploying network services (NS) based on one or more virtualized network functions (VNFs) available in a communication network, such as described above in relation to FIG. 9.

As a whole, communication system 1000 of FIG. 10 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1002 is a cellular network that implements 3GPP standardized features. Accordingly, telecommunication network 1002 may support network slicing to provide different logical networks to different devices that are connected to telecommunication network 1002. For example, telecommunication network 1002 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1012 are configured to transmit and/or receive information without direct human interaction. For instance, a UE may be designed to transmit information to the access network 1004 on a predetermined schedule, when triggered by an internal or external event, or in response to requests from the access network 1004. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

As shown in FIG. 10, hub 1014 communicates with the access network 1004 to facilitate indirect communication between one or more UEs (e.g., UE 1012c and/or 1012d) and network nodes (e.g., network node 1010b). In some examples, hub 1014 may be a controller, router, content source and analytics, or any of the other communication devices described herein regarding UEs. For example, hub 1014 may be a broadband router enabling access to core network 1006 for the UEs. As another example, hub 1014 may be a controller that sends commands or instructions to one or more actuators in the UEs.

FIG. 11 shows a network node 1100 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

In some embodiments, network node 1100 can be configured to perform various operations of exemplary methods (e.g., procedures) for deploying network services (NS) based on one or more virtualized network functions (VNFs) available in a communication network, such as described above in relation to FIG. 9.

Network node 1100 includes a processing circuitry 1102, a memory 1104, a communication interface 1106, and a power source 1108. Network node 1100 may be composed of multiple physically separate components (e.g., a NodeB component and a RNC component, or a BTS component and a BSC component, etc.), which may each have their own respective components. In certain scenarios in which network node 1100 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1100 may be configured to support multiple radio access technologies (RATs). In such embodiments, some components may be duplicated (e.g., separate memory 1104 for different RATs) and some components may be reused (e.g., a same antenna 1110 may be shared by different RATs). Network node 1100 may also include multiple sets of the various illustrated components for different wireless technologies integrated into network node 1100, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1100.

Processing circuitry 1102 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1100 components, such as memory 1104, to provide network node 1100 functionality.

In some embodiments, processing circuitry 1102 includes a system on a chip (SOC). In some embodiments, processing circuitry 1102 includes one or more of radio frequency (RF) transceiver circuitry 1112 and baseband processing circuitry 1114. In some embodiments, the radio frequency (RF) transceiver circuitry 1112 and baseband processing circuitry 1114 may be on separate chips (or sets of chips), boards, or units, such as radio units and digital units. In alternative embodiments, part or all of RF transceiver circuitry 1112 and baseband processing circuitry 1114 may be on the same chip or set of chips, boards, or units.

Memory 1104 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1102. Memory 1104 may store any suitable instructions, data, or information, including a computer program, software, an application including one or more of logic, rules, code, tables, and/or other instructions (collectively denoted computer program product 1104a) capable of being executed by processing circuitry 1102 and utilized by network node 1100. Memory 1104 may be used to store any calculations made by processing circuitry 1102 and/or any data received via communication interface 1106. In some embodiments, processing circuitry 1102 and memory 1104 is integrated.

Communication interface 1106 is used in wired or wireless communication of signaling and/or data between a network node, access network, and/or UE. As illustrated, communication interface 1106 comprises port(s)/terminal(s) 1116 to send and receive data, for example to and from a network over a wired connection. Communication interface 1106 also includes radio front-end circuitry 1118 that may be coupled to, or in certain embodiments a part of, antenna 1110. Radio front-end circuitry 1118 comprises filters 1120 and amplifiers 1122. Radio front-end circuitry 1118 may be connected to an antenna 1110 and processing circuitry 1102. The radio front-end circuitry may be configured to condition signals communicated between antenna 1110 and processing circuitry 1102. Radio front-end circuitry 1118 may receive digital data that is to be sent out to other network nodes or UEs via a wireless connection. Radio front-end circuitry 1118 may convert the digital data into a radio signal having the appropriate channel and bandwidth parameters using a combination of filters 1120 and/or amplifiers 1122. The radio signal may then be transmitted via antenna 1110. Similarly, when receiving data, antenna 1110 may collect radio signals which are then converted into digital data by radio front-end circuitry 1118. The digital data may be passed to processing circuitry 1102. In other embodiments, the communication interface may comprise different components and/or different combinations of components.

In certain alternative embodiments, network node 1100 does not include separate radio front-end circuitry 1118, instead, processing circuitry 1102 includes radio front-end circuitry and is connected to antenna 1110. Similarly, in some embodiments, all or some of RF transceiver circuitry 1112 is part of communication interface 1106. In still other embodiments, communication interface 1106 includes one or more ports or terminals 1116, radio front-end circuitry 1118, and RF transceiver circuitry 1112, as part of a radio unit (not shown), and communication interface 1106 communicates with baseband processing circuitry 1114, which is part of a digital unit (not shown).

Antenna 1110 may include one or more antennas, or antenna arrays, configured to send and/or receive wireless signals. Antenna 1110 may be coupled to radio front-end circuitry 1118 and may be any type of antenna capable of transmitting and receiving data and/or signals wirelessly. In certain embodiments, antenna 1110 is separate from network node 1100 and connectable to network node 1100 through an interface or port.

Antenna 1110, communication interface 1106, and/or processing circuitry 1102 may be configured to perform any receiving operations and/or certain obtaining operations described herein as being performed by the network node. Any information, data and/or signals may be received from a UE, another network node and/or any other network equipment. Similarly, antenna 1110, communication interface 1106, and/or processing circuitry 1102 may be configured to perform any transmitting operations described herein as being performed by the network node. Any information, data and/or signals may be transmitted to a UE, another network node and/or any other network equipment.

Power source 1108 provides power to the various components of network node 1100 in a form suitable for the respective components (e.g., at a voltage and current level needed for each respective component). Power source 1108 may further comprise, or be coupled to, power management circuitry to supply the components of network node 1100 with power for performing the functionality described herein. For example, network node 1100 may be connectable to an external power source (e.g., the power grid, an electricity outlet) via an input circuitry or interface such as an electrical cable, whereby the external power source supplies power to power circuitry of power source 1108. As a further example, power source 1108 may comprise a source of power in the form of a battery or battery pack which is connected to, or integrated in, power circuitry. The battery may provide backup power should the external power source fail.

Embodiments of network node 1100 may include additional components beyond those shown in FIG. 11 for providing certain aspects of the network node's functionality, including any of the functionality described herein and/or any functionality necessary to support the subject matter described herein. For example, network node 1100 may include user interface equipment to allow input of information into network node 1100 and to allow output of information from network node 1100. This may allow a user to perform diagnostic, maintenance, repair, and other administrative functions for network node 1100.

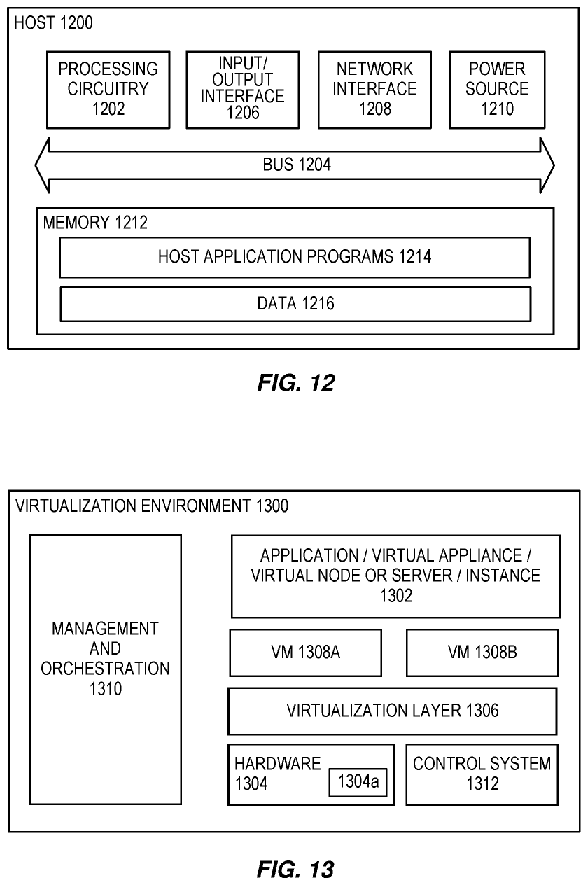

FIG. 12 is a block diagram of a host 1200, which may be an embodiment of host 1016 of FIG. 10, in accordance with various aspects described herein. As used herein, host 1200 may be or comprise various combinations hardware and/or software, including a standalone server, a blade server, a cloud-implemented server, a distributed server, a virtual machine, container, or processing resources in a server farm. Host 1200 may provide one or more services to one or more UEs.

Host 1200 includes processing circuitry 1202 that is operatively coupled via a bus 1204 to an input/output interface 1206, a network interface 1208, a power source 1210, and a memory 1212. Other components may be included in other embodiments. Features of these components may be substantially similar to those described with respect to the devices of previous figures, such as FIG. 11, such that the descriptions thereof are generally applicable to the corresponding components of host 1200.

Memory 1212 may include one or more computer programs including one or more host application programs 1214 and data 1216, which may include user data, e.g., data generated by a UE for host 1200 or data generated by host 1200 for a UE. Embodiments of host 1200 may utilize some or all of the components shown. Host application programs 1214 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1214 may also provide for user authentication and licensing checks and may periodically report health, routes, and content availability to a central node, such as a device in or on the edge of a core network. Accordingly, host 1200 may select and/or indicate a different host for over-the-top services for a UE. Host application programs 1214 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

In some embodiments, host 1200 can be configured to perform various operations of exemplary methods (e.g., procedures) for deploying network services (NS) based on one or more virtualized network functions (VNFs) available in a communication network, such as described above in relation to FIG. 9.

FIG. 13 is a block diagram illustrating a virtualization environment 1300 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1300 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1302 (which may alternatively be called software instances, virtual appliances, network functions, virtual nodes, virtual network functions, etc.) are run in the virtualization environment 1300 to implement some of the features, functions, and/or benefits of some of the embodiments disclosed herein.

Hardware 1304 includes processing circuitry, memory that stores software and/or instructions (collectively denoted computer program product 1304a) executable by hardware processing circuitry, and/or other hardware devices as described herein, such as a network interface, input/output interface, and so forth. Software may be executed by the processing circuitry to instantiate one or more virtualization layers 1306 (also referred to as hypervisors or virtual machine monitors (VMMs)), provide VMs 1308a-b (one or more of which may be generally referred to as VMs 1308), and/or perform any of the functions, features and/or benefits described in relation with some embodiments described herein. The virtualization layer 1306 may present a virtual operating platform that appears like networking hardware to the VMs 1308.

VMs 1308 comprise virtual processing, virtual memory, virtual networking or interface and virtual storage, and may be run by a corresponding virtualization layer 1306. Different embodiments of the instance of a virtual appliance 1302 may be implemented on one or more of VMs 1308, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, VM 1308 may be a software implementation of a physical machine that runs programs as if they were executing on a physical, non-virtualized machine. Each VM 1308, and that part of hardware 1304 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1308 on top of hardware 1304 and corresponds to application 1302.

Hardware 1304 may be implemented in a standalone network node with generic or specific components. Hardware 1304 may implement some functions via virtualization. Alternatively, hardware 1304 may be part of a larger cluster of hardware (e.g., such as in a data center or CPE) where many hardware nodes work together and are managed via management and orchestration function 1310, which, among others, oversees lifecycle management of applications 1302. In some embodiments, management and orchestration function 1310 can be configured to perform various operations of exemplary methods (e.g., procedures) for deploying network services (NS) based on one or more virtualized network functions (VNFs) available in a communication network, such as described above in relation to FIG. 9.

In some embodiments, hardware 1304 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1312 which may alternatively be used for communication between hardware nodes and radio units.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

Embodiments of the techniques and apparatus described herein also include, but are not limited to, the following enumerated examples:
A1. A method for deploying network services (NS) based on one or more virtualized network functions (VNFs) available in a communication network, the method comprising:
   obtaining a first NS descriptor (NSD) of a first NS, wherein the first NSD includes the following:
      an identifier of a VNF descriptor (VNFD) of a constituent VNF of the NS, and
      a first service access point descriptor (SAPD) of a first SAP of the NS, wherein:
      the constituent VNF includes a plurality of virtualization deployment units (VDUs) that are not required to be included in instantiations of the constituent VNF,
      the VNFD indicates a first one of the VDUs that is associated with a first deployable module (DM) of the constituent VNF,
      the first VDU includes a first connection point (CP), which the VNFD indicates as an external CP for the constituent VNF, and
      the first SAPD includes the following attributes associated with the first SAP: an identifier of VNFD as a constituent element, an identifier of the first CP, and a first mapping between the first CP and the first DM.
A2. The method of embodiment A1, further comprising determining one or more of the following first information based on the first SAPD in the first NSD: that the first DM has been instantiated, that the first CP has been instantiated, and that external connectivity is needed for the first SAP.
A3. The method of embodiment A2, wherein the first information is determined based on the first SAPD without accessing the VNFD of the constituent VNF.
A4. The method of any of embodiments A1-A3, wherein the first NSD also includes an identifier of the first DM of the constituent VNF.
A5 The method of embodiment A4, wherein the identifier of the first DM, included in the first NSD, includes a qualifier associated with the VNFD of the constituent VNF.
A6. The method of any of embodiments A1-A5, further comprising deploying the first NS in the communication network, in accordance with the obtained first NSD.
A7. The method of any of embodiments A1-A5, wherein:
   the first NS is nested in a composite NS;
   the first NSD is obtained as part of a second NSD for the composite NS;
   the second NSD includes an identifier of the first NSD and a second SAPD of a second SAP of the composite NS; and
   the second SAPD includes the following attributes associated with the second SAP: an identifier of the first NSD as a constituent element, an identifier of the first SAPD, and a second mapping between the first SAPD and the first DM.
A8. The method of embodiment A7, further comprising determining one or more of the following second information based on the second SAPD in the second NSD: that the first DM has been instantiated, that the first SAP has been instantiated, and that external connectivity is needed for the second SAP.
A9. The method of embodiment A8, wherein the second information is determined based on the second SAPD without accessing the first NSD.
A10. The method of any of embodiments A7-A9, wherein the second NSD also includes an identifier of the first DM of the constituent VNF.
A11. The method of embodiment A10, wherein the identifier of the first DM, included in the second NSD, includes qualifiers associated with the following: the VNFD of the constituent VNF, and the first NSD.
A12. The method of any of embodiments A7-A11, further comprising deploying the second NS in the communication network, in accordance with the obtained second NSD.
A13. The method of any of embodiments A1-A12, wherein the method is performed by one of the following associated with the communication network: a NFV management and orchestration (MANO) function, an operations support system (OSS), and a business support system (BSS).
B1. A network management function configured to deploy network services (NS) based on one or more virtualized network functions (VNFs) available in a communication network, wherein:
   the network management function is implemented by communication interface circuitry and processing circuitry that are operably coupled, and
   the processing circuitry and the communication interface circuitry are configured to perform operations corresponding to any of the methods of embodiments A1-A13.
B2. A network management function configured to deploy network services (NS) based on one or more virtualized network functions (VNFs) available in a communication network, the network analytics system being further configured to perform operations corresponding to any of the methods of embodiments A1-A13.
B3. A non-transitory, computer-readable medium storing computer-executable instructions that, when executed by processing circuitry associated with a network management function configured to deploy network services (NS) based on one or more virtualized network functions (VNFs) available in a communication network, configure the network management system to perform operations corresponding to any of the methods of embodiments A1-A13.
B4. A computer program product comprising computer-executable instructions that, when executed by processing circuitry associated with a network management function configured to deploy network services (NS) based on one or more virtualized network functions (VNFs) available in a communication network, configure the network management system to perform operations corresponding to any of the methods of embodiments A1-A13.

1.-21. (canceled)

22. A computer-implemented method for deploying network services (NS) based on one or more virtualized network functions (VNFs) available in a communication network, the method comprising:
obtaining a first NS descriptor (NSD) of a first NS, wherein:
the first NSD includes the following:
an identifier of a VNF descriptor (VNFD) of a constituent VNF of the NS, and
a first service access point descriptor (SAPD) of a first SAP of the NS; and
the first SAPD includes the following attributes associated with the first SAP:
an identifier of the VNFD as a constituent element of the first SAP,
an identifier of a first connection point (CP) of the VNFD, and
a first mapping between the first CP and a first deployable module (DM) of the constituent VNF.

23. The method of claim 22, wherein:
the constituent VNF includes a plurality of virtualization deployment units (VDUs) that are not required to be included in instantiations of the constituent VNF,
the VNFD indicates a first one of the VDUs that is associated with the first DM of the constituent VNF, and
the first VDU includes the first CP, which the VNFD indicates as an external CP for the constituent VNF.

24. The method of claim 22, further comprising determining one or more of the following first information based on the first SAPD of the first NSD: that the first DM has been instantiated, that the first CP has been instantiated, and that external connectivity is needed for the first SAP.

25. The method of claim 24, wherein the first information is determined based on the first SAPD without accessing the VNFD of the constituent VNF.

26. The method of claim 23, wherein the first NSD also includes an identifier of the first DM of the constituent VNF.

27. The method of claim 26, wherein the identifier of the first DM, included in the first NSD, includes a qualifier associated with the VNFD of the constituent VNF.

28. The method of claim 22, further comprising deploying the first NS in the communication network, in accordance with the obtained first NSD.

29. The method of claim 22, wherein:
the first NS is nested in a composite NS;
the first NSD is obtained as part of a second NSD for the composite NS;
the second NSD includes an identifier of the first NSD and a second SAPD of a second SAP of the composite NS; and
the second SAPD includes the following attributes associated with the second SAP: an identifier of the first NSD as a constituent element, an identifier of the first SAPD, and a second mapping between the first SAPD and the first DM.

30. The method of claim 29, further comprising determining one or more of the following second information based on the second SAPD in the second NSD: that the first DM has been instantiated, that the first SAP has been instantiated, and that external connectivity is needed for the second SAP.

31. The method of claim 30, wherein the second information is determined based on the second SAPD without accessing the first NSD.

32. The method of claim 29, wherein the second NSD also includes an identifier of the first DM of the constituent VNF.

33. The method of claim 32, wherein the identifier of the first DM, included in the second NSD, includes qualifiers associated with the following: the VNFD of the constituent VNF, and the first NSD.

34. The method of claim 29, further comprising deploying the second NS in the communication network, in accordance with the obtained second NSD.

35. The method of claim 22, wherein the method is performed by one of the following associated with the communication network: a NFV management and orchestration (MANO) function, an operations support system (OSS), and a business support system (BSS).

36. Network equipment arranged to implement a network management function configured to deploy network services (NS) based on one or more virtualized network functions, VNFs available in a communication network, the network equipment comprising processing circuitry configured to:
obtain a first NS descriptor (NSD) of a first NS, wherein:
the first NSD includes the following:
an identifier of a VNF descriptor (VNFD) of a constituent VNF of the NS, and
a first service access point descriptor (SAPD) of a first SAP of the NS; and
the first SAPD includes the following attributes associated with the first SAP:
an identifier of the VNFD as a constituent element of the first SAP,
an identifier of a first connection point (CP) of the VNFD, and
a first mapping between the first CP and a first deployable module (DM) of the constituent VNF.

37. The network equipment of claim 36, wherein the processing circuitry and the communication interface circuitry are further configured to determine one or more of the following first information based on the first SAPD of the first NSD: that the first DM has been instantiated, that the first CP has been instantiated, and that external connectivity is needed for the first SAP.

38. The network equipment of claim 37, wherein the first information is determined based on the first SAPD without accessing the VNFD of the constituent VNF.

39. The network equipment of claim 36, wherein the processing circuitry and the communication interface circuitry are further configured to deploy the first NS in the communication network, in accordance with the obtained first NSD.

40. The network equipment of claim 36, wherein:
the first NS is nested in a composite NS;
the first NSD is obtained as part of a second NSD for the composite NS;
the second NSD includes an identifier of the first NSD and a second SAPD of a second SAP of the composite NS; and
the second SAPD includes the following attributes associated with the second SAP: an identifier of the first NSD as a constituent element, an identifier of the first SAPD, and a second mapping between the first SAPD and the first DM.

41. A communication network comprising:
a virtualization environment arranged to host virtualized network functions (VNFs); and
a network management function configured to deploy network services (NS) based on VNFs hosted by the virtualization environment, wherein the network management function is further configured to:
obtain a first NS descriptor (NSD) of a first NS, wherein:
the first NSD includes the following:
an identifier of a VNF descriptor (VNFD) of a constituent VNF of the NS, and
a first service access point descriptor (SAPD) of a first SAP of the NS; and
the first SAPD includes the following attributes associated with the first SAP:
an identifier of the VNFD as a constituent element of the first SAP,
an identifier of a first connection point (CP) of the VNFD, and
a first mapping between the first CP and a first deployable module (DM) of the constituent VNF; and
deploy the first NS in the communication network, in accordance with the obtained first NSD.
